(19) United States
(12) Patent Application Publication
(10) Pub. No.: US 2010/0040871 A1
(43) Pub. Date: Feb. 18, 2010

(54) HARD COAT FILM AND LAYERED MATERIAL

(75) Inventors: Masato Saito, Saitama (JP); Masuo Koyama, Saitama (JP); Yukio Kishi, Saitama (JP)

Correspondence Address: BACON & THOMAS, PLLC, 625 SLATERS LANE, FOURTH FLOOR, ALEXANDRIA, VA, 22314-1176, US

(73) Assignee: KIMOTO CO., LTD., Tokyo (JP)

(21) Appl. No.: 12/528,532

(22) PCT Filed: Feb. 15, 2008
(86) PCT No.: PCT/JP2008/052542

§ 371 Date: Aug. 25, 2009

(30) Foreign Application Priority Data
Mar. 8, 2007 (JP) 2007-058325

(51) Int. Cl. B32B 27/08; C08G 63/06; C08G 77/04; C08F 265/00

(52) U.S. Cl. 428/335; 528/361; 528/26; 525/305

(57) ABSTRACT

The hard coat film 1 of the present invention shows a contact angle for water of 110 degrees or smaller and a contact angle for camellia oil of 50 degrees or smaller. According to the present invention, even if fingerprints are adhered to the hard coat film 1, these fingerprints are inconspicuous. The hard coat film 1 of the present invention preferably shows a contact angle for water of 50 degrees or larger and a wet tension of 27 to 45 mN/m. With these characteristics, in addition to inconspicuousness of fingerprints, wiping-off property for fingerprints is improved.

### TECHNICAL FIELD

The present invention relates to a hard coat film and a layered material (laminate).

### BACKGROUND ART

A coated layer consisting of a cured coating composition containing a siloxane compound is known (Patent document 1).

Patent document 1: Japanese Patent Unexamined Publication (KOKAI) No. 2006-188557 (Paragraph 0013)

### DISCLOSURE OF THE INVENTION

### Object to be Achieved by the Invention

However, according to the technique of Patent document 1, strong water repellency and oil repellency are imparted to the coated layer due to the influence of the siloxane compound. Therefore, the coated layer has a problem that when a fingerprint is adhered on the coated layer, the adhered fingerprint is conspicuous on the coated layer surface, and hence appearance of the coated layer is degraded.

An object to be achieved by the present invention is to provide a hard coat film on which fingerprints adhered to the film are inconspicuous, and a laminate comprising such a hard coat film.

### Means for Achieving the Object

The present invention achieves the aforementioned object by adjusting contact angles for water and camellia oil of a hard coat film to be within predetermined ranges.

### EFFECT OF THE INVENTION

According to the present invention, surface characteristics of a hard coat film are appropriately controlled, and therefore even if fingerprints are adhered to the film, they can be made inconspicuous. As a result, degradation of appearance of the film can be prevented.

### BRIEF DESCRIPTION OF THE DRAWINGS

FIG. 1 is a conceptual drawing for explaining surface conditions of a hard coat film according to the present invention.

FIG. 2 is a conceptual drawing for explaining surface conditions of a hard coat film of which wet tension is too low.

FIG. 3 is a conceptual drawing for explaining surface conditions of a hard coat film of which wet tension is too high.

### DESCRIPTION OF NOTATIONS

1, 1a, 1b . . . . Hard coat film
2 . . . . Aqueous component (fingerprint component)
3 . . . Oil component (fingerprint component)

### BEST MODE FOR CARRYING OUT THE INVENTION

Hereafter, embodiments of the hard coat film and laminate of the present invention will be explained.

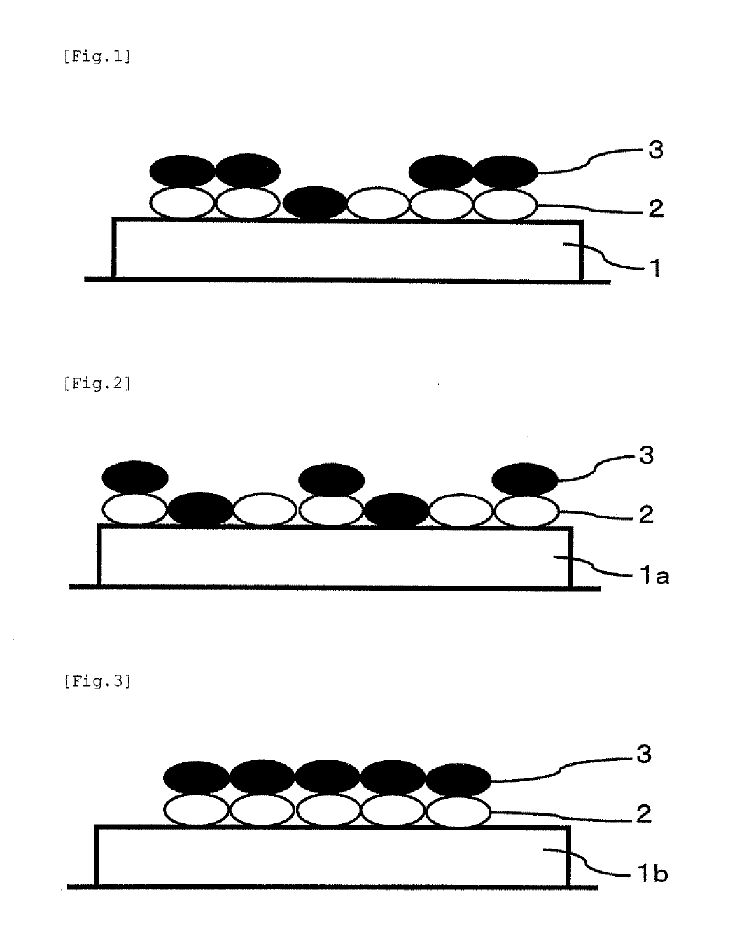

In the hard coat film 1 of the present invention shown in FIG. 1, surface characteristics thereof are appropriately adjusted. Specifically, contact angle for water of the surface is adjusted to be smaller than a specific value, and contact angle for camellia oil of the surface is also adjusted to be smaller than a specific value.

The inventors of the present invention found that, in order to make fingerprints adhered on a surface of a hard coat film 1 inconspicuous (improvement in invisibility of adhered fingerprints), it was effective to impart appropriate hydrophilicity and lipophilicity to the surface of the coated film, not to impart strong water repellency and oil repellency. Surface characteristics of the hard coat film 1 were examined on the basis of the aforementioned finding, and it was found that appropriate hydrophilicity and lipophilicity could be imparted to the surface by adjusting the surface characteristics of the hard coat film 1 so that contact angle for water and contact angle for camellia oil of the surface should be smaller than specific values, respectively.

Since the surface of the hard coat film 1 of the present invention shows appropriate hydrophilicity and lipophilicity, contact area of fingerprint components (consisting of aqueous component and oil component) to the coated film surface does not become unduly small, and the fingerprint components can be spread on the film surface with appropriately wetting the film surface. As a result, even when a fingerprint is adhered on the surface of the hard coat film 1, the adhered fingerprint can be made inconspicuous (improvement in invisibility of adhered fingerprints).

In the present invention, in addition to such improvement in invisibility of adhered fingerprints, degradation of the hard coat property of the coated film (hardness of coated film) is also prevented. That is, in the hard coat film 1 of the present invention, both performances of improvement in invisibility of adhered fingerprints and prevention of degradation of the hard coat property are achieved with good balance of them.

Moreover, the inventors of the present invention also found that by adjusting the contact angle for water to be equal to or larger than a predetermined angle, and wet tension of the surface to be within a predetermined range, in addition to the adjustment mentioned above, wiping-off property for adhered fingerprints was made favorable, and fingerprint components remaining even after wiping could also be made inconspicuous, besides that the effects of the improvement in invisibility of adhered fingerprints and the prevention of degradation of the hard coat property were provided.

In the present invention, contact angle for water of the hard coat film 1 is preferably adjusted to be 110° or smaller, more preferably 100° or smaller. If the contact angle for water is adjusted to be 110° or smaller, the contact area of fingerprint components with water is not become unduly small, and adhered fingerprints can be made inconspicuous (improvement in invisibility of adhered fingerprints).

In the present invention, contact angle for camellia oil of the hard coat film 1 is preferably adjusted to be 50° or smaller, more preferably 40° or smaller. If the contact angle for camellia oil is adjusted to be 50° or smaller, oil component contained in fingerprints spreads with wetting the surface. Therefore, adhered fingerprints become inconspicuous (improvement in invisibility of adhered fingerprints), and fingerprint components remaining after wiping can also be made inconspicuous.

In the present invention, contact angle for water of the hard coat film 1 is preferably adjusted to be 50° or larger, more preferably 60° or larger, still more preferably 70° or larger, particularly preferably 80° or larger. If the contact angle for water is adjusted to be 50° or larger, the contact area with water is not become unduly large. As a result, aqueous component contained in fingerprints more easily separates, and the wiping-off property for fingerprints is improved. That is, in the present invention, by adjusting contact angle for water of the hard coat film 1 to be within a predetermined range, the wiping-off property for fingerprints can also be improved, in addition to the improvement in invisibility of adhered fingerprints.

Both of values of the contact angle for water and contact angle for camellia oil are values measured by the method according to JIS-R3257 (1999).

In the present invention, wet tension of the hard coat film 1 is preferably adjusted to be 27 mN/m or larger, more preferably 30 mN/m or larger. Wet tension of the hard coat film 1 is also preferably adjusted to be 45 mN/m or smaller, more preferably 40 mN/m or smaller, still more preferably 38 mN/m or smaller.

By adjusting wet tension of the hard coat film 1 to be within a predetermined ranger wiping-off property for fingerprints can be improved. Although the reason why such an effect is obtained is not necessarily clear, it can be assumingly considered as follows. When wet tension of the hard coat film 1 is adjusted to be within the predetermined range, aqueous component 2 in fingerprints is more likely to show appropriate affinity to the surface of the hard coat film 1, and the aqueous component 2 and the oil component 3 will exist on the hard coat film 1 in an appropriately mixed state. That is, since much of aqueous component 2 will be present on the hard coat film 1, the oil component 3 becomes hard to remain on the surface of the hard coat film 1 when the fingerprint components are wiped off. And since some oil component 3 will remain on the surface of the hard coat film 1, degree of hydrophilicity of the surface of the hard coat film 1 does not become unduly high. As a result, the aqueous component 2 may be prevented from becoming hard to be separated from the surface of the hard coat film 1, and the wiping of property for fingerprints may be improved.

On the other hand, if wet tension of the hard coat film 1a is unduly low as shown in FIG. 2, the oil component 3 contained in fingerprints may show affinity to the surface in a degree as high as that of the aqueous component 2, and therefore too much oil component 3 is present on the surface of the hard coat film 1a. As a result, even after wiping off the fingerprints, it may become more likely that the oil component 3 remains on the surface of the hard coat film 1a, and thus the wiping-off property for fingerprints may be degraded.

Moreover, if wet tension of the hard coat film 1b is unduly high as shown in FIG. 3, the aqueous component 2 of fingerprints comes to show higher affinity compared with the oil component 3, and degree of hydrophilicity of the surface of the hard coat film 1b becomes unduly high. As a result, the aqueous component 2 present on the surface of the hard coat film 1b becomes hard to be separated from the surface of the hard coat film 1b, and thus the wiping-off property for fingerprints may be degraded.

The values of wet tension are values measured by the method according to JIS-K6768 (1999).

In FIG. 1 again, pencil scratch value of the hard coat film 1 of the present invention is preferably adjusted to be H or higher, more preferably 2H or higher. By adjusting the pencil scratch value to be not lower than a predetermined value, scratch on the surface of the hard coat film 1 can be effectively prevented without degrading improvement in invisibility of adhered fingerprints nor fingerprint wiping-off property.

The values of pencil scratch value are values measured by the method according to JIS-K 5600-5-4 (1999).

The hard coat film 1 of the present invention is preferably further adjusted to have a refractive index value of 1.45 to 1.65, more preferably 1.46 to 1.52. By adjusting the value of refractive index to be within a predetermined range, difference of the refractive index of the hard coat film 1 and the refractive index of fingerprint components can be made small. As a result, even when fingerprints are adhered on the hard coat film 1, the adhered fingerprints are more inconspicuous (further improvement in invisibility of adhered fingerprints), and fingerprint components after wiping can also be made inconspicuous.

The hard coat film 1 of the present invention preferably has a thickness not smaller than about 0.1 μm and not larger than about 30 μm. With a thickness not smaller than 0.1 μm, the hard coat film 1 can be made a coated film having sufficient hardness. On the other hand, even if the thickness of the hard coat film 1 is made larger than 30 μm, hardness of the coated film is not further improved. Moreover, when the thickness of the hard coat film 1 becomes larger, it tends to cause curling due to shrinkage of the coated film. Therefore, a thickness of 30 μm or smaller is preferred from the viewpoints of economy and anti-curling property. In the present invention, it is also possible to make the hard coated film 1 a thin film having a thickness of about 10 μm or smaller, or a further thinner film having a thickness of about 5 μm or smaller. Even as such a thin film, the necessary performances can be obtained at sufficient levels.

In addition, in the present invention, the surface of the hard coat film 1 may be further subjected to a surface treatment, such as plasma treatment, corona discharge treatment and far ultraviolet ray irradiation treatment, in order to obtain the aforementioned surface properties.

The hard coated film 1 of the present invention can be obtained by preparing a curable composition (coating material), applying it on a desired object of application and curing it.

The laminate of the present invention comprises an object of application on which the hard coat film 1 is formed.

The curable composition which can be used for the present invention comprises a resin component. The resin component comprises either one or both of a thermosetting resin and an ionizing radiation curable resin.

The thermosetting resin and the ionizing radiation curable resin are constituted with, for example, polyester type resins, acrylic type resins, acrylic urethane type resins, polyester acrylate type resins, polyurethane acrylate type resins, epoxy acrylate type resins, urethane type resins, epoxy type resins, polycarbonate type resins, melamine type resins, phenol type resins, silicone type resins, fluorocarbon type resins, and so forth.

The resin component preferably contains at least the ionizing radiation curable resin especially from the viewpoint of obtaining superior hardness of coated film (hard coat property) after curing.

As the ionizing radiation curable resin, photopolymerizable prepolymers which cure by crosslinking upon irradiation of ionizing radiation (ultraviolet ray or electron beam) can be used. In the present invention, the photopolymerizable prepolymers mentioned below may be used independently or as a combination of two or more kinds of them.

The photopolymerizable prepolymers are divided into those of cationic polymerization type and those of radical polymerization type.

Examples of the cationic polymerization type photopolymerizable prepolymers include epoxy resins, vinyl ether resins, and so forth. Examples of the epoxy resins include, for example, bisphenol type epoxy resins, novolak type epoxy resins, alicyclic epoxy resins, aliphatic epoxy resins, and so forth.

As the radical polymerization type photopolymerizable prepolymers, acrylic type prepolymers (hard prepolymers) which have two or more acryloyl groups in the molecule and forms a three-dimensional reticular structure by curing via crosslinking are particularly preferably used from the viewpoint of hard coat property.

Examples of the acrylic type prepolymers include urethane acrylates, polyester acrylates, epoxy acrylates, melamine acrylates, polyfluoroalkyl acrylates, silicone acrylates, and so forth.

The urethane acrylate type prepolymers can be obtained by, for example, esterifying a polyurethane oligomer, which is obtainable by a reaction of a polyether polyol or a polyester polyol and a polyisocyanate, by a reaction with a (meth)acrylic acid. The polyester acrylate type prepolymers can be obtained by, for example, esterifying hydroxyl group of a polyester oligomer having hydroxyl groups at both ends, which is obtainable by condensation of a polybasic carboxylic acid and a polyhydric alcohol, with (meth)acrylic acid, or by esterifying hydroxyl group at an end of an oligomer, which is obtainable by adding alkylene oxide to a polybasic carboxylic acid, with (meth)acrylic acid. The epoxy acrylate type prepolymers can be obtained by, for example, esterifying an oxirane ring of a bisphenol type epoxy resin or a novolak type epoxy resin having a relatively low molecular weight by a reaction with (meth)acrylic acid.

The acrylic type prepolymers can be suitably chosen according to type, use, etc. of a member as an object of application. Moreover, although acrylic type prepolymers can be used independently, it is preferable to add a photopolymerizable monomer in order to impart various performances, such as improvement in crosslinking curing property and adjustment of shrinkage after curing Examples of the photopolymerizable monomer include monofunctional acrylic monomers (for example, 2-ethylhexyl acrylate, 2-hydroxyethyl acrylate, 2-hydroxypropyl acrylate, butoxyethyl acrylate etc.), bifunctional acrylic monomers (for example, 1,6-hexanediol diacrylate, neopentylglycol diacrylate, diethylene glycol diacrylate, polyethylene glycol diacrylate, neopentylglycol hydroxypivalate diacrylate etc.), and trifunctional acrylic monomers and those of further higher functionality (for example, dipentaerythritol hexaacrylate, trimethylpropane triacrylate, pentaerythritol triacrylate etc.). The “acrylate” not only literally includes acrylates, but also includes methacrylates. These photopolymerizable monomers may be used independently, or as a combination of two or more kinds of them.

Total content (in terms of solid content) of the photopolymerizable prepolymer and the photopolymerizable monomer based on the total resin component contained in the curable composition of the present invention is preferably to 99% by weight, more preferably 60 to 95% by weight, still more preferably 80 to 90% by weight.

When the hard coat film 1 of the present invention is used after formation thereof by curing with ultraviolet irradiation, it is preferable to add additives including photopolymerization initiators, photopolymerization enhancers and ultraviolet sensitizers to the curable composition of the present invention.

Examples of the photopolymerization initiators for the radical polymerization type photopolymerizable prepolymers and photopolymerizable monomers includes for example, acetophenone, benzophenone, Michler's ketone, benzoin, benzyl methyl ketal, benzoyl benzoate, α-acyl oxime ester, thioxansones, and so forth. Examples of the photopolymerization initiators for the cationic polymerization type photopolymerizable prepolymers include, for example, compounds formed from an onium such as aromatic sulfonium ions, aromatic oxosulfonium ions and aromatic iodonium ions, and an anion such as tetrafluoroborate, hexafluorophosphate, hexafluoroantimonate and hexafluoroarsenate. These may be used independently, or as a combination of two or more kinds of them.

Examples of the photopolymerization enhancers include p-dimethylaminobenzoic acid isoamyl ester, p-dimethylaminobenzoic acid ethyl ester, and so forth.

Examples of the ultraviolet sensitizers include n-butylamine, triethylamine, tri-n-butylphosphine, and so forth.

Amounts of these additives are usually selected to be within the range of 0.2 to 10 parts by weight based on 100 parts by weight of the total amount of the photopolymerizable prepolymer and the photopolymerizable monomer mentioned above.

Although resin components containing an ionizing radiation curable resin is specifically exemplified in this specification, a thermosetting resin may be contained in the resin component instead of or in addition to the ionizing radiation curable resin. When a thermosetting resin is contained in the resin component, thermally polymerizable monomers and prepolymers are used independently or in combination, and a thermal polymerization initiator, i.e., a compound which generates active radical species upon heating, or the like is added as required.

Examples of the thermal polymerization initiator include, for example, peroxides, azo compounds, and so forth. Specific examples include benzoyl peroxide, t-butyl peroxybenzoate, azobisisobutyronitrile, and so forth.

In the present invention, the resin component may contain, besides the aforementioned thermosetting resin or ionizing radiation curable resin, other resins such as a thermoplastic resin to such an extent that the effect of the present invention should not be degraded.

The curable composition of the present invention may optionally contain additive components as required to such an extent that the effect of the present invention should not be degraded. Examples of the additive components include, for example, surface regulators, lubricants, colorants, pigments, dyes, optical whitening agents, flame retardants, antibacterial agents, antifungal agents, ultraviolet absorbers, light stabilizers, heat stabilizers, antioxidants, plasticizers, leveling agents, flow regulators, antifoams, dispersing agents, storage stabilizers, crosslinking agents, and so forth.

In the present invention, it is preferable to add a compound having an HLB value within a predetermined range as determined by the Griffin method (nonionic compound) as the additive component.

Examples of the compound preferred as the additive component include nonionic compounds having an HLB value of, for example, 2 or larger, preferably 5 or larger, more preferably 10 or larger, and, for example, 18 or smaller, preferably 15 or smaller, as determined by the Griffin method, and so forth. If a nonionic compound of which HLB value is appropriately adjusted is added, it becomes easy to adjust contact angle for water and contact angle for camellia oil as well as wet tension of the hard coat film 1 to be within the predetermined ranges described above.

The term “nonionic compound” generically refers to compounds which dissolve in water, but do not act as ions, and such compounds are formed by bonding a hydrophobic group (lipophilic group) and a hydrophilic group in combination.

Such compounds are compounds having at least one kind of hydrophilic group (for example, polyalkylene oxide group, hydroxyl group, carboxyl group, sulfonyl group, phosphoric acid group, amino group, isocyanate group, glycidyl group, alkoxysilyl group, ammonium salt group, various metal salt groups, etc.), and examples include, for example, ethoxylated glycerin triacrylate, ethoxylated bisphenol A diacrylate, polyethylene glycol diacrylate, polyether-denatured acrylate, polyhydroxy-denatured acrylate, and so forth. Among these, polyethylene glycol diacrylate is preferably used from the viewpoints of solubility in solvent and handling property.

As the nonionic compound, fatty acid esters, polyethers, and so forth can also be used.

Examples of the fatty acid esters include fatty acid esters formed by condensation of a monohydric alcohol or a polyhydric alcohol of di- or higher hydricity and an aliphatic acid, for example, propylene glycol monostearate, propylene glycol monolaurate, diethylene glycol monostearate, diethylene glycol monolaurate, glycerol monostearate, sorbitan sesquioleate, sorbitan monooleate, sorbitan monostearate, sorbitan monopalmitate, sorbitan monolaurate, and so forth. Examples of the fatty acid ester also include polyoxy alkylene-added fatty acid esters.

In addition, a nonionic compound formed by addition polymerization of alkylene oxide on a fatty acid ester may also be added. As the alkylene oxide to be addition-polymerized, ethylene oxide or propylene oxide is preferred. Ethylene oxide and propylene oxide may be independently addition-polymerized, or they may be addition-copolymerized.

Examples of the polyoxyalkylene-added fatty acid ester include, for example, polyoxyethylene hydrogenated castor oil, polyoxyethyleneglycerin monostearate, polyoxyethylene (4) sorbitan monostearate, polyoxyethylene (20) sorbitan monostearate, polyoxyethylene (4) sorbitan tristearate, polyoxyethylene (5) sorbitan monooleate, polyoxyethylene (5) sorbitan monooleate, polyoxyethylene (20) sorbitan trioleate, polyoxyethylene (4) sorbitan monolaurate, polyoxyethylene glycol 400 monooleate, polyoxyethylene glycol 400 monostearate, polyethylene glycol 400 monolaurate, polyoxyethylene (4) sorbitan monolaurate, and so forth.

In the present invention, as compounds other than fatty acid ester or polyether, polyoxyethylene cholesteryl ethers, polyoxyethylene decyl tetradecyl ethers, and so forth may also be used.

Content of the compound having an HLB value within a predetermined range as determined by the Griffin method is preferably 0.05 part by weight or more, more preferably 0.1 part by weight or more, still more preferably 1 part by weight or more, and preferably 60 parts by weight or less, more preferably 15 parts by weight or less, still more preferably 10 parts by weight or less, based on 100 parts by weight of the resin component. By using the compound in an amount not less than 0.1 part by weight as the lower limit of the content, it becomes easy to adjust contact angle for water, contact angle for camellia oil, and wet tension of the hard coat film 1 to be within the predetermined ranges mentioned above. Further, by using the compound in an amount not more than 60 parts by weight as the upper limit of the content, decrease of the hardness of the surface of the hard coat film 1 (hard coat property) can be prevented. It is expected that by adding the compound in an appropriate amount, the wiping-off property for fingerprints of the hard coat film 1 should be further improved.

The curable composition of the present invention is usually realized in the form of a coating material. When it is formed as an organic solvent type coating material, a curable composition can be produced by dissolving or dispersing the resin component mentioned above (and an additive component as required) with a dilution solvent such as an organic solvent, which can be suitably chosen according to the type of the resin component, and adding an additive as required. Although the organic solvent is not particularly limited, examples include alcohols (for example, methanol, ethanol, isopropanol, butanol, octanol etc.), ketones (for example, acetone, methyl ethyl ketone (MEK), methyl isobutyl ketone, cyclohexanone etc.), esters (for example, ethyl acetate, butyl acetate, ethyl lactate, γ-butyrolactone, propylene glycol monomethyl ether acetate, propylene glycol monoethyl ether acetate etc.), ethers (for example, ethylene glycol monomethyl ether, diethylene glycol monobutyl ether etc.), aromatic hydrocarbons (for example, benzene, toluene, xylene etc.), and amides (for example, dimethylformamide, N,N-dimethylacetamide, N-methylpyrrolidone etc.). When the curable composition is formed as a solventless coating material, a curable composition can be formed by adding an additive component to the resin component mentioned above as required.

The object of application is a base material to which hard coat property (scratch resistance) and effect of improvement in adhered fingerprint invisibility are desired to be imparted. Shape of the base material used for the present invention is not particularly limited, and the base material may have any shape having an arbitrary thickness such as shapes of film, sheet and plate. Further, the base material may have, for example, an uneven surface, or the base material may have a three-dimensional shape having a three-dimensionally curved surface.

Material of the base material is not also particularly limited. Although it may be a hard base material such as glass plates, it is preferably a resin base material having flexibility in the present invention. Type of the resin which constitutes the resin base material is not particularly limited. Examples of the resin for forming the resin base material in the shape of, for example, film or sheet include, for example, acrylic resin, polycarbonate, polyvinyl chloride, polyester, polypropylene, polyethylene, acetyl cellulose, cycloolefin, and so forth. Examples of the resin for forming the resin base material in the shape of plate include, for example, acrylic resin, polycarbonate, polyvinyl chloride, and so forth.

In the present invention, surface of the base material may be subjected to an adhesion promoting treatment in order to improve adhesion of the base material with the hard coat film 1 constituted with a cured product of the curable composition mentioned above. Examples of the adhesion promoting treatment include, for example, plasma treatment, corona discharge treatment, far ultraviolet ray irradiation treatment, formation of adhesion promoting undercoat layer, and so forth.

In addition, the base material may contain additives similar to the additives that can be contained in the curable composition of the present invention such as pigments and ultraviolet absorbers to such an extent that the effect of the present invention should not be degraded.

Application (coating) of the curable composition to an object of application may be performed by a conventional method such as bar coating, die coating, blade coating, spin coating, roll coating, photogravure coating, flow coating, dip coating, spray coating, screen printing and brush coating.

In the present invention, the curable composition is applied so that the applied coated film should preferably have a thickness not smaller than about 0.1 μm and not larger than about 30 μm after drying and curing described later. After the curable composition is applied to an object of application, the applied coated film is preferably dried at about 50 to 120° C.

Curing of the curable composition can be attained by subjecting the applied coated film to thermal curing and/or irradiation of ionizing radiation (light).

When thermal curing is performed, for example, an electric heater, an infrared lamp, hot wind, and so forth can be used as the heat source.

When curing is attained by using ionizing radiation (light), the source of radiation is not particularly limited, so long as the curable composition applied on the base material can be cured in a short time. For example, examples of infrared radiation source include lamps, resistance heating boards, lasers, and so forth. Examples of visible light source include sunlight, lamps, fluorescent lights, lasers, and so forth. Examples of ultraviolet ray (ionizing radiation) source include ultrahigh pressure mercury lamps, high pressure mercury lamps, low pressure mercury lamps, carbon arc, metal halide lamps, and so forth. Ultraviolet rays in a wavelength region of 100 to 400 nm, preferably 200 to 400 nm, emitted from such ultraviolet ray sources as mentioned above are irradiated. Examples of electron beam (ionizing radiation) source include electron beam accelerators of scanning type, curtain type, etc. Electron beams in a wavelength region of 100 nm or smaller emitted from such electron beam accelerators as mentioned above are irradiated.

Irradiation dose of ionizing radiation changes depending on type of the ionizing radiation. For example, in the case of ultraviolet ray, the dose is preferably about 100 to 500 mJ/cm² as an amount of light, and in the case of electron beam, the dose is preferably about 10 to 1000 krad.

The hard coat film 1 of the present invention produced as described above is suitably used for uses which require impartation of hard coat property (scratch resistance) and effect of improvement in adhered fingerprint invisibility, in particular, as hard coat films for various displays (for example, plasma display panel (PDP), cathode ray tube (CRT), liquid crystal display (LCD), electroluminescence display (ELD) etc.); glass for showcases, cover glass of watches and gauges; touching surfaces of touch panel type electronic equipments, of which typical examples are ATMs in banks and ticket machines, and so forth.

The electronic equipments of course include information processing devices having such various displays as mentioned above, such as cellular phones (including, for example, portable personal information terminals having PDA (Personal Digital Assistants) functions) and personal computers.

In order to prevent scratches, hard coat films are conventionally provided on surfaces of various displays (including touch panels) directly, or indirectly by adhering hard coat film laminates formed by providing a hard coat film on a transparent base material on them. Since the hard coat films and hard coat film laminates used for such uses are highly transparent, when fingerprints are adhered on the hard coat films, they are very conspicuous, and the hard coat films cannot be made clean even if they are wiped with cloth or the like.

Since surface of the hard coat film 1 of the present invention shows appropriate hydrophilicity and lipophilicity, contact area of fingerprint components (consisting of aqueous component and oil component) with the coated film surface does not become unduly small, and thus the fingerprint components can be spread on the coated film surface with wetting the surface. As a result, even when fingerprints are adhered to the surface of the hard coat film 1, the adhered fingerprints can be made inconspicuous (improvement in invisibility of adhered fingerprints). In the present invention, besides such improvement in invisibility of adhered fingerprints, degradation of the hard coat property of the coated film (hardness of coated film) is also prevented. That is, the hard coat film 1 of the present invention shows both performances of improvement in invisibility of adhered fingerprints and prevention of degradation of hard coat property with good balance of them.

Furthermore, since surface of the hard coat film 1 of the present invention shows appropriate hydrophilicity and lipophilicity, it shows favorable wiping-off property for adhered fingerprints, and fingerprint components remaining even after wiping can also be made inconspicuous.

### EXAMPLES

Hereafter, the present invention will be explained in more detail with reference to experimental examples in which embodiments of the present invention are more specifically realized. In the experimental examples, the term “part” and the symbol “%” are used on weight basis unless otherwise specified.

### Experimental Example 1

First, a coating solution (curable composition) was prepared.

<Composition of coating solution>

| | | |
|---|---|---|
| Ionizing radiation curable resin composition | 10 | parts |
| (solid content: 100%, Beamset 575, | | |
| Arakawa Chemical Industries, Ltd.) | | |
| Nonionic compound (solid content: 100%, | 5 | parts |
| polyethylene glycol diacrylate, | | |
| HLB value: 17, NK ester A-1000, | | |
| Shin-Nakamura Chemical Co., Ltd.) | | |
| Photopolymerization initiator | 0.5 | part |
| (Irgacure 651, Ciba Speciality | | |
| Chemicals Inc.) | | |
| Propylene glycol monomethyl ether | 23 | parts |

Then, the prepared coating solution was applied to one surface of a polyester film having a thickness 125 μm (COSMOSHINE A4300, Toyobo Co., Ltd.) as an object of application by bar coating method, and dried to form a coated film.

Then, the formed coated film was irradiated with ultraviolet ray emitted from a high pressure mercury lamp (irradiation dose: 400 mJ/cm²) to obtain a sample of a laminate (hard coat film laminate) having a hard coat film having a thickness of 6 μm.

Contact angle for water, contact angle for camellia oil, and wet tension of the obtained laminate sample were measured according to the following methods, and the sample was evaluated for adhered fingerprint invisibility, fingerprint wiping-off property and pencil hardness. The results are shown in Table 1.

(1) Both of contact angle for water and contact angle for camellia oil were measured on the hard coat film of the laminate sample according to the methods of JIS-R3257 (1999).
(2) Wet tension was measured on the hard coat film of the laminate sample according to the method of JIS-K6768 (1999).
(3) Adhered fingerprint invisibility was evaluated as follows. First, inside of a finger was pressed against the surface of the hard coat film of the laminate sample to adhere a fingerprint. Then, the laminate sample adhered with the fingerprint was put on a black material so that the side of the member as the object of application of the laminate sample should face the black material. Then, the fingerprint was observed from right above on the hard coat film side of the laminate sample under illumination with a three band fluorescent light. The evaluation results are shown with “⊚” when the fingerprint could not be seen, with “◯” when the fingerprint was hardly seen, with “Δ” when the fingerprint could be slightly seen, or with “X” when the fingerprint was clearly seen.
(4) Fingerprint wiping-off property was evaluated as follows. First, inside of a finger was pressed against the surface of the hard coat film of the laminate sample to adhere a fingerprint. Then, paper tissue (Kleenex, Nippon Paper Crecia Co., Ltd.) was contacted with the hard coat film adhered with the fingerprint, and reciprocally moved to wipe off the fingerprint. Then, the laminate sample adhered with the fingerprint was put on a black material so that the side of the member as the object of application of the laminate sample should face the black material. Then, the laminate sample was obliquely observed from the hard coat film side under illumination with a three band fluorescent light to examine the condition of the hard coat film after wiping off of the fingerprint. The evaluation results are shown with “⊚” when less than two times of the reciprocal movements were required until the fingerprint became invisible, with “◯” when not less than two times but less than three times of the reciprocal movements were required until the fingerprint became invisible, with “Δ” when not less than three times but less than five times of the reciprocal movements were required until the fingerprint became invisible, or with “X” when not less than five times of the reciprocal movements were required until the fingerprint became invisible, or the fingerprint did not become invisible.
(5) As for pencil hardness, pencil scratch value of the hard coat film surface of the laminate sample was measured by the method according to JIS-K 5600-5-4 (1999). The evaluation results are shown with “⊚” when the measured value was 2H or higher, or with “X” when the measured value was lower than H.

### Experimental Example 2

A coating solution was prepared, and a laminate sample was obtained in the same manner as that of Experimental Example 1, except that 0.5 part of acrylic resin beads having a mean particle diameter of 6 μm (MR7HG, Soken Chemical & Engineering Co., Ltd.) were added as a matting agent. Then, the same measurements and evaluations as those of Experimental Example 1 were performed. The results are shown in Table 1.

### Experimental Example 3

A coating solution was prepared, and a laminate sample was obtained in the same manner as that of Experimental Example 1, except that the surface of the hard coat film was subjected to a corona discharge treatment.

Then, the same measurements and evaluations as those of Experimental Example 1 were performed. The results are shown in Table 1.

### Experimental Example 4

A coating solution was prepared, and a laminate sample was obtained in the same manner as that of Experimental Example 1, except that 0.02 part of a nonionic compound (polyether-denatured dimethylpolysiloxane, solid content: 100%, trade name: BYK333, BYK Japan KK) was added. Then, the same measurements and evaluations as those of Experimental Example 1 were performed. The results are shown in Table 1.

### Experimental Example 5

A coating solution was prepared, and a laminate sample was obtained in the same manner as that of Experimental Example 4, except that 0.04 part of BYK333 was added. Then, the same measurements and evaluations as those of Experimental Example 1 were performed. The results are shown in Table 1.

### Experimental Example 6

A coating solution was prepared, and a laminate sample was obtained in the same manner as that of Experimental Example 4, except that another nonionic compound (fluorine type additive, solid content: 20%, trade name: Megafac F484, Dainippon Ink & Chemicals, Inc.) was added instead of BYK333. Then, the same measurements and evaluations as those of Experimental Example 1 were performed. The results are shown in Table 1.

### Experimental Example 7

A coating solution was prepared, and a laminate sample was obtained in the same manner as that of Experimental Example 4, except that another nonionic compound (acrylic type copolymer, solid content: 52%, trade name: BYK355, BYK Japan KK) was added instead of BYK333. Then, the same measurements and evaluations as those of Experimental Example 1 were performed. The results are shown in Table 1.

### Experimental Example 8

A coating solution was prepared, and a laminate sample was obtained in the same manner as that of Experimental Example 4, except that 0.05 part of another nonionic compound (polyether-denatured dimethylpolysiloxane, solid content: 100%, trade name: BYK331, BYK Japan KK) was added instead of BYK333. Then, the same measurements and evaluations as those of Experimental Example 1 were performed. The results are shown in Table 1.

### Experimental Example 9

A coating solution was prepared, and a laminate sample was obtained in the same manner as that of Experimental Example 3, except that the surface of the hard coat film was subjected to a corona discharge treatment. Then, the same measurements and evaluations as those of Experimental Example 1 were performed. The results are shown in Table 1.

### Experimental Example 10

A coating solution was prepared, and a laminate sample was obtained in the same manner as that of Experimental Example 6, except that the amount of Megafac F484 was change to 0.05 part. Then, the same measurements and evaluations as those of Experimental Example 1 were performed. The results are shown in Table 1.

### Experimental Example 11

A coating solution was prepared, and a laminate sample was obtained in the same manner as that of Experimental Example 8, except that the amount of BYK331 was change to 0.02 part. Then, the same measurements and evaluations as those of Experimental Example 1 were performed. The results are shown in Table 1.

### Experimental Example 12

A coating solution was prepared, and a laminate sample was obtained in the same manner as that of Experimental Example 1, except that the irradiation dose of ultraviolet light was changed to 50 mJ/cm². Then, the same measurements and evaluations as those of Experimental Example 1 were performed. The results are shown in Table 1.

### Experimental Example 13

A coating solution was prepared, and a laminate sample was obtained in the same manner as that of Experimental Example 1, except that the amount of Beamset 575 was changed to 17 parts, the amount of Irgacure 651 was changed to 0.4 part, the amount of propylene glycol monomethyl ether was changed to 30 parts, and 3 parts of a nonionic compound (solid content: 100%, substance name: isocyanuric acid triacrylate, HLB value: 12, trade name: SR368, Sartomer Company Inc.) was added instead of polyethylene glycol diacrylate. Then, the same measurements and evaluations as those of Experimental Example 1 were performed. The results are shown in Table 1.

### Experimental Example 14

A coating solution was prepared, and a laminate sample was obtained in the same manner as that of Experimental Example 13, except that 0.5 part of another nonionic compound (polyether, trade name: Peretex PC2419, Miyoshi Oil & Fat Co., Ltd., HLB value: 6) was added. Then, the same measurements and evaluations as those of Experimental Example 1 were performed. The results are shown in Table 1.

TABLE 1

| | Surface characteristics | | | | | |
|---|---|---|---|---|---|---|
| | | Contact | | | | |
| | Contact | angle for | | Evaluation | | |
| | angle for | camellia | | | Fingerprint | |
| | water | oil | Wet tension | Fingerprint | wiping-off | Pencil |
| | (degree) | (degree) | (mN/m) | invisibility | property | hardness |
| Experimental Example 1 | 80 | 20 | 33 | ⊚ | ⊚ | ⊚ |
| Experimental Example 2 | 85 | 15 | 34 | ⊚ | ⊚ | ⊚ |
| Experimental Example 3 | 60 | 10 | 38 | ⊚ | ◯ | ⊚ |
| Experimental Example 4 | 90 | 45 | 30 | ◯ | ⊚ | ⊚ |
| Experimental Example 5 | 100 | 50 | 28 | ◯ | ◯ | ⊚ |
| Experimental Example 6 | 90 | 47 | 27 | ◯ | ◯ | ⊚ |
| Experimental Example 7 | 75 | 15 | 40 | ⊚ | ◯ | ⊚ |
| Experimental Example 8 | 112 | 65 | 18 | X | X | ⊚ |
| Experimental Example 9 | 45 | 5 | 40 | ⊚ | X | ⊚ |
| Experimental Example 10 | 100 | 60 | 25 | Δ | Δ | ⊚ |
| Experimental Example 11 | 100 | 50 | 22 | ◯ | X | ⊚ |
| Experimental Example 12 | 60 | 15 | 50 | ⊚ | X | X |
| Experimental Example 13 | 63 | 25 | 45 | ⊚ | ◯ | ⊚ |
| Experimental Example 14 | 63 | 37 | 37 | ⊚ | ⊚ | ⊚ |

The followings could be confirmed from the results shown in Table 1.

First, as for the adhered fingerprint invisibility, when both contact angle for water and contact angle for camellia oil exceeded the predetermined angles (Experimental Example 8), or when contact angle for water was smaller than the predetermined angle, but contact angle for camellia oil exceeded the predetermined angle (Experimental Example 10), fingerprints adhered to the hard coat films were conspicuous in both cases. In contrast, when both the contact angles were smaller than the predetermined angles (Experimental Examples 1 to 7, 9, 11 to 14), fingerprints adhered to the hard coat films were inconspicuous. Especially when both contact angles were appropriately adjusted (Experimental Examples 1 to 3, 7, 13 and 14), the adhered fingerprints became more inconspicuous.

As for the fingerprint wiping-off property, when wet tension was within the predetermined ranger but contact angle for water was unduly small (Experimental Example 9), or when wet tension was out of the predetermined range (Experimental Examples 8, 10 to 12), fingerprints adhered to the hard coat films could not be easily wiped off. In contrast, if wet tension was within the predetermined range (Experimental Examples 1 to 7, 13 and 14), fingerprints adhered to the hard coat film could be easily wiped off.

As for pencil hardness, favorable results were obtained for the samples of all the experimental examples except for Experimental Example 12.

From these results, it could be confirmed that those showing both superior adhered fingerprint invisibility and superior fingerprint wiping-off property with maintaining pencil hardness were those of Experimental Examples 1 to 7, 13 and 14, and among these, those showing particularly superior results were those of Experimental Examples 1 to 3, 7, 13 and 14. That is, it could be confirmed that, in the samples of Experimental Examples 1 to 3, 7, 13 and 14, the hard coat property was not decreased without degrading appropriate balance of hydrophilicity of and lipophilicity of the hard coat films.

1. A hard coat film showing a contact angle for water of 110 degrees or smaller and a contact angle for camellia oil of 50 degrees or smaller.

2. The hard coat film according to claim 1, which shows a contact angle for water of 50 degrees or larger and a wet tension of 27 to 45 mN/m.

3. The hard coat film according to claim 2, which is formed by irradiating a curable composition containing at least an ionizing radiation curable resin and a compound showing an HLB value of 2 to 18 as determined by the Griffin method with ionizing radiation to cure the composition.

4. A laminate having the hard coat film according to claim 3.

5. The laminate according to claim 4, wherein the hard coat film has a thickness of 0.1 to 30 μm.

6. An electronic equipment having the hard coat film according to claim 1.

7. The electronic equipment according to claim 6, wherein the hard coat film has a thickness of 0.1 to 30 μm.

8. The electronic equipment according to claim 7, which is a cellular phone.

9. The hard coat film according to claim 1, which is formed by irradiating a curable composition containing at least an ionizing radiation curable resin and a compound showing an HLB value of 2 to 18 as determined by the Griffin method with ionizing radiation to cure the composition.

10. A laminate having the hard coat film according to claim 1.

11. The laminate according to claim 10, wherein the hard coat film has a thickness of 0.1 to 30 μm.

12. A laminate having the hard coat film according to claim 2.

13. The laminate according to claim 12, wherein the hard coat film has a thickness of 0.1 to 30 μm.

14. An electronic equipment having the hard coat film according to claim 2.

15. The electronic equipment according to claim 14, wherein the hard coat film has a thickness of 0.1 to 30 μm.

16. An electronic equipment having the hard coat film according to claim 3.

17. The electronic equipment according to claim 16, wherein the hard coat film has a thickness of 0.1 to 30 μm.

18. The electronic equipment according to claim 6, which is a cellular phone.
